(19) United States
(12) Patent Application Publication
(10) Pub. No.: US 2008/0003478 A1
(43) Pub. Date: Jan. 3, 2008

(54) High Temperature Solid Electrolyte Fuel Cell and Fuel Cell Installation Built with Said Fuel Cell

(75) Inventors: Horst Greiner, Forchheim (DE); Joachim Grosse, Erlangen (DE); Wilhelm Kleinlein, Furth (DE); Norbert Landgraf, Ruckersdorf (DE); Werner Merz, Heroldsberg (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, Munchen (DE)

(21) Appl. No.: 11/597,582

(22) PCT Filed: May 20, 2005
(86) PCT No.: PCT/EP05/52330

§ 371 Date: Sep. 5, 2007

(30) Foreign Application Priority Data
May 28, 2004 (DE) 10 2004 026 714.6
Mar. 14, 2005 (DE) 10 2005 011 669.8

(51) Int. Cl. H01M 8/12; H01M 8/24

(52) U.S. Cl. 429/31; 429/30

(57) ABSTRACT

Solid ceramic fuel cells operating at high temperatures are already known. This type of fuel cell is particularly the so-called solid oxide fuel cell (SOFC). In principle, the SOFC can be built in accordance with a planar concept or a tubular concept. The tubular concept has already been further developed in the so-called HPD configuration. According to an embodiment of the invention, the surface of the support structure in a delta fuel cell is geometrically enlarged in part in order to obtain an enlarged electrochemically active surface. Advantageously, at least one device for deflecting air from one direction to other directions is integrated into the support structure.

### PRIORITY STATEMENT

This application is the national phase under 35 U.S.C. § 371 of PCT International Application No. PCT/EP2005/052330 which has an International filing date of May 20, 2005, which designated the United States of America and which claims priority on German Patent Application numbers 10 2004 026 714.6 filed May 28, 2004, and 10 2005 011 669.8 filed Mar. 14, 2005, the entire contents of which are hereby incorporated herein by reference.

### FIELD

Embodiments of the invention generally relate to a high-temperature solid-electrolyte fuel cell, in particular based on the tube or HPD concept. Embodiments of the invention additionally also generally relate to an associated fuel cell installation, which is constructed from fuel cells such as these.

### BACKGROUND

Specific fuel cells are known for power generation. In particular, these are high-temperature fuel cells with a solid-ceramic electrolyte, which are referred to as SOFC (Solid Oxide Fuel Cell).

SOFC fuel cells are known in a planar and tubular form, the latter of which is described in detail in VIK Reports “Fuel cells”, No. 214, November 1999, pages 49 et seq. Planar fuel cells can be produced in a folded form, in which case a fuel cell installation having a stack structure is produced from a large number of folded individual fuel cells in a monolithic block (“Fuel cells and Their Applications” (VCH Verlagsgesellschaft mbH 1996, E4, FIG. E20.5). It has not yet been possible to produce fuel cells such as these.

In the case of a tubular fuel cell, individual fuel cell tubes are electrically connected in series and/or in parallel in groups. So-called HPD (High Power Density) fuel cells have been developed from tubular fuel cells (literature reference: “The Fuel Cell World (2004)”—Proceedings, pages 258-267), in which the functional layers, in particular such as the solid-ceramic electrolyte and the anode, are applied externally to a flat sintered body which forms the cathode and has parallel recesses. With its internal recesses, the cathode is used as an air electrode, and the anode as a fuel electrode. Interconnectors with nickel electrodes are provided on the flat face for connection of a plurality of such HPD cells. In comparison to individual tubular fuel cells, the HPD concept is more powerful, more compact and in particular can be handled more easily.

Furthermore, EP 0 320 087 B1 discloses a fuel cell arrangement, for which a zigzag geometry of the supporting structure is shown in FIG. 4. In particular, the description relates to the intermediate structures for gas guidance. The document does not describe the efficiency and power density of a fuel cell arrangement such as this.

In this case, the structure is based on the prior U.S. Pat. No. 4,467,198 A, which describes a high-temperature solid-electrolyte fuel cell installation having an intermonolithic stack. In this case, individual fuel cells are produced separately with triangular or wave structures, and are connected by suitable connection techniques to form the monolith. Finally, WO 02/37589 A2 discloses a high-temperature solid-electrolyte fuel cell, in which a stack of individual fuel cells with different structures is joined together to form a monolith. In this case, in particular, the channels of the individual fuel cells have corners and/or edges which can be used as attachment points for high mechanical stresses and thus adversely affect the long-term stability of the overall arrangement.

### SUMMARY

At least one embodiment of the invention achieves a further performance improvement and increases in the packing density of electrode-based solid-electrolyte fuel cells based on a tubular concept or HPD concept, and creates an associated fuel cell installation.

In at least one embodiment of the invention, the porous, electrically conductive material forms a wave-like supporting structure for the electrochemically active functional layers. Corresponding gas line channels, which likewise have rounded edges and/or corners in the cross section, are integrated in this wave-like supporting structure, which contains rounded edges. That part of the supporting structure surface to which the functional layers are applied is geometrically enlarged by shaping, so that this results in an enlarged electrochemically active area.

Flat membranes composed of ceramic and in this case with the membranes forming so-called multichannel elements are admittedly already known from the “Handbuch der Keramik” (DVS Verlag GmbH Dusseldorf 2004 [Manual of Ceramics]; Group IIK 2.1.4, Series 418, the entire contents of which are incorporated herein by reference. A corrugated structure with hollow channels is applied to a planar flat body for this purpose.

Membranes such as these are used in particular as separating tools for the filtration of liquids. Transfer to fuel cell technology is not obvious since this relates to a purely mechanical filtering application which has no electrochemical converter functions whatsoever, in which case, in addition to the boundary area size, electrical and ionic conductivities and transport phenomena are also required, as well as electrical connection technology for high temperatures between 900 and 1000° C.

Various embodiments are possible within the scope of the invention. In detail, these include:
the surface structure has a uniform shape in one direction, that is to say in the pressing direction during shaping. It can be extruded in this shape. Alternatively, it can be composed of two extrudates/films.
The surface structure can be further enlarged, for example after shaping.
The surface structure is shaped such that the electrochemically active layers, that is to say the anode, electrolyte, cathode, can be applied over the complete area by coating processes or immersion processes, possibly in conjunction with sintering steps for subsequent compression. On the planar rear face, the functional layers are interrupted only by a gas-tight interconnector layer, which can likewise be applied using a coating process or immersion process, in order to make contact with the adjacent cell via suitable contact elements. This thus results in fully electrochemically functional individual cells.
Widely differing surface structures are possible for the invention. Examples of this are: corrugated sheet-metal shape (delta), wedge-shaped, cuboid (so-called “crenulations”), semicircular, meandering shape, upwards/downwards staircases and combinations between them.

A supporting structure composed of anode material is possible as an alternative to the supporting structure composed of cathode material.

The gas-permeable supporting structure can also be electrochemically neutral, for example being composed of porous metal or porous ceramic.

The important factor is that, in the case of a fuel cell installation according to the invention, a contact is made from one individual cell to another individual cell by means of flexible metallic moldings via the interconnector layers, in order to form a stack. By way of example, the contact is made from the anode of one cell to the cathode of the other cell via the interconnector layer, for which purpose, for example, it is possible to use metal mesh, meshes, knitted fabrics, felts, composed, for example, of nickel, or nickel or chromium alloys, as the contact element between the cells.

By way of example, especially for production of the solid-electrolyte fuel cell as an SOFC, the supporting structure is composed, for example, of doped LaCaMnO₃ (cathode-supported) or Ni—YSZ-Cermet (anode-supported). The electrolyte is composed, for example, of Y- or Sc-stabilized zirconium oxide.

In the case of at least one embodiment of the invention, a fuel cell stack can be formed by connection of the individual cells in series and/or in parallel with a flexible contact molding, held together by boards. In this case, the media can be guided in particular in three different ways:
parallel, that is to say the air on the inside and the natural gas/fuel outside the cell (cathode-supported) or vice versa (anode-supported),
alternately “up/down” between individual cell channels within the cell, which requires a gas guidance termination at one cell end,
“up/down” in two adjacent cells, which requires a cell connector between the two cells.

In the case of the fuel cell installation according to at least one embodiment of the invention, it is advantageous:
that combustion of the residual gas across gaps is possible if the cells are sealed at one end in an air/gas-supply board without air deflection in the cell (“once through”) and with an installation without any seals at the other end, so that the cells are fixed only at one end, so that no mechanical longitudinal stresses are applied when thermally loaded,
if the cells in the boards are sealed at both ends, the fuel and air circuits are separated, and this can be used, for example, for hydrogen or carbon-dioxide separation.

With regard to the fuel cell installation according to at least one embodiment of the invention:
the fuel flow is guided either parallel (flow in the same direction), parallel in opposite directions (opposing flow) or at right angles (cross-flow) to the air,
the supporting structure from one cell to the adjacent cell is arranged in the same sense or offset in order to form a stack.

For the purposes of at least one embodiment of the invention, an alternate “up/down” flow between individual cell channels can advantageously be achieved within the cell, with this being ensured by the gas guidance termination at one cell end. In this context, WO 03/012907 A1 has admittedly already disclosed HPD fuel cells in which the direction of the air flow is in each case reversed in pairs in adjacent channels, after which the air is emitted at the side. However, the solutions proposed there cannot be transferred to the cell geometry as described here and structured on one side, since this refers to plane-parallel flat cell structures.

At least one embodiment of the invention now provides the widest possible design options with regard to the choice of the air guidance channels on the one hand and the configuration of the fuel cell installation with fuel cells stacked to form bundles, on the other hand. In particular, the simple stacking capability of the individual fuel cells resulting from the end fittings and their gas-tight soldering to form a compact module is advantageous in comparison to the prior art.

### BRIEF DESCRIPTION OF THE DRAWINGS

Further details and advantages of the invention will become evident from the following description of the figures of example embodiments on the basis of the drawing and in conjunction with the patent claims. In the figures, in each case illustrated schematically:

FIG. 1 shows a detail from the novel fuel cell, in the form of a section,

FIG. 2b to FIG. 2g show different alternatives for the cross section of the fuel cell shown in FIG. 1, with FIG. 2a illustrating the prior art,

FIG. 3 shows a configuration for a stack with at least two fuel cells connected via an interconnector, which results in a periodic structure,

FIG. 4 shows the configuration of a stack corresponding to that in FIG. 3, but in which this results in a shifted fuel cell structure,

FIG. 5 shows a perspective illustration of a fuel cell with internal devices, arranged at the closed end, for air deflection,

FIG. 6 shows a first alternative to FIG. 5 with external devices for air deflection,

FIG. 7 shows a second alternative to FIG. 5 with external devices connecting all of the channels,

FIG. 8 shows a perspective illustration of the open end of a fuel cell bundle composed of individual fuel cells as shown in FIGS. 5 to 7,

FIG. 9 shows an overall view of a fuel cell bundle for formation of a fuel cell installation,

FIG. 10 shows a section through the molding at the open end of the fuel cell bundle as shown in FIG. 9, with devices for air inlet and outlet, and

FIG. 11 shows a plan view of the fuel cell bundle shown in FIG. 9, from the inlet side.

### DETAILED DESCRIPTION OF THE EXAMPLE EMBODIMENTS

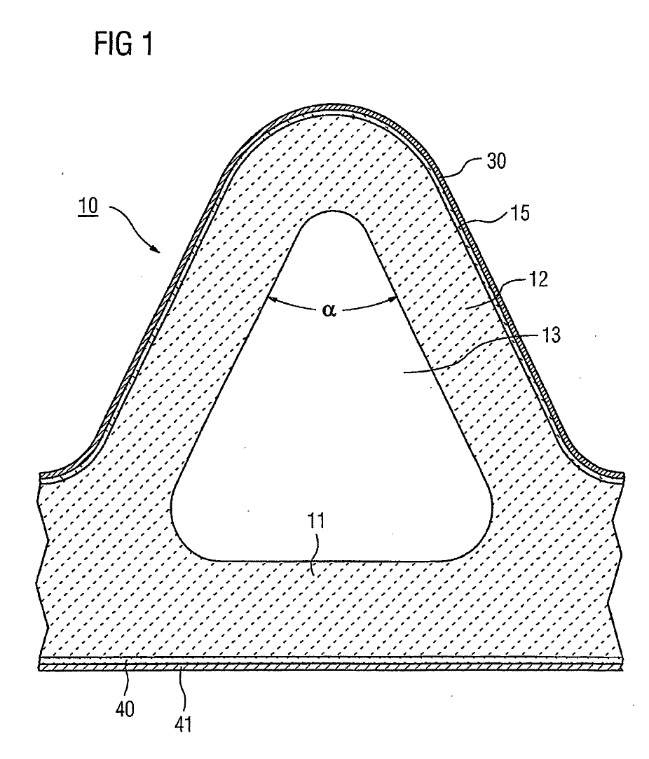

FIG. 1 shows a detail of a single fuel cell. This includes a ceramic structure 10 with a flat base 11 and a structure 12 with a specific shape located on it. The structure may, for example, be a wave or a triangular structure (delta), in particular with the apex angle α of this structure being predetermined. For example, angles of 60, 45 or 30° may be provided.

The base part 11 and the structure 12 may form a common unit, and may be extruded jointly from the ceramic material. The two parts may, however, also be produced separately, then being placed one on top of the other.

The structures formed in this way each enclose an internal volume 13 through which a medium can flow. In particular in order to provide a cathode-supported fuel cell, the ceramic structure provides the cathode and is composed either of LaCaMnO₃ or of LaCa(Sr)MnO₃, with the further functional layers being applied to the upper face of the structure. In particular, this is the solid electrolyte 15 composed of Y- or Sc-stabilized zirconium oxide and the anode 30 composed, for example, of Ni—YSZ Cermet, with these specific ceramic materials being known from the prior art.

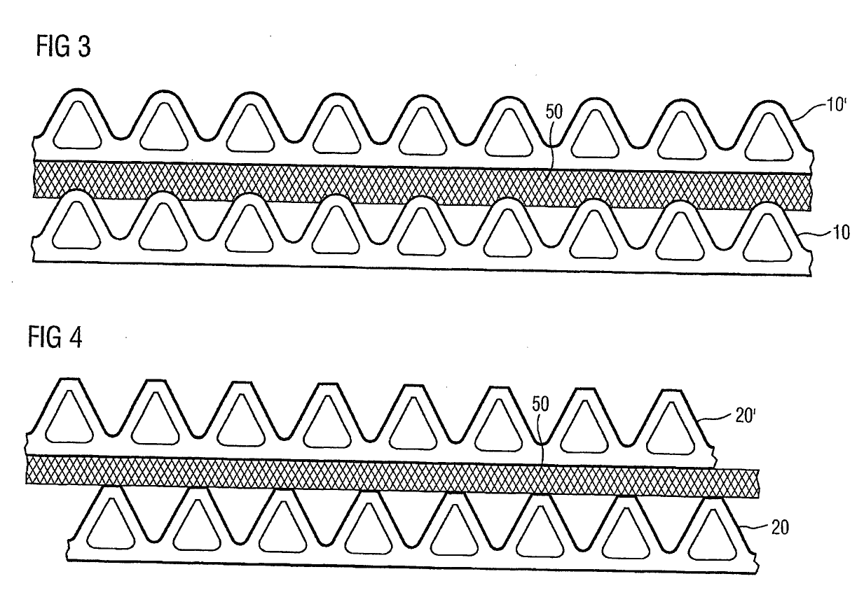

An interconnector strip 40 is located on the lower face, with nickel plating 41 for connection of a first fuel cell to a second fuel cell, in which case, in this context, reference is also made to the description of FIG. 3, further below.

One major feature of the structure shown in FIG. 1 (delta) is that the electrochemically active surface is enlarged in comparison to the known HPD fuel cell with a flat surface. This is achieved by the wave structure or triangular structure as shown in FIG. 1, in which case the flanks can be stepped in order to additionally enlarge the surface.

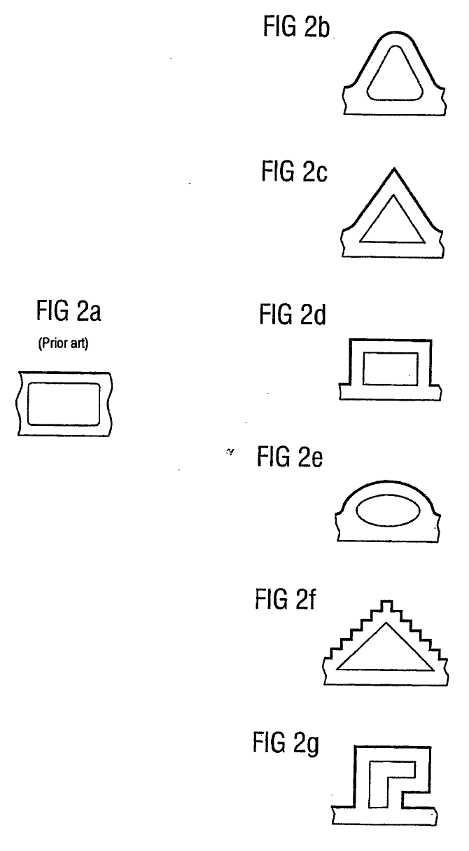

FIGS. 2b to 2g show various suitable shapes: for comparison, FIG. 2a shows an elementary element of an HPD fuel cell according to the prior art. In addition to the wave shape shown in FIG. 2b, a triangular shape can also be specified, as shown in FIG. 2c. In addition, quadrilateral shapes as shown in FIG. 2d are also possible, which form so-called “crenulations”. Further shapes are possible with a continuously curved surface, in particular in the form of an oval 4 as shown in FIG. 2e, or a stepped triangle as shown in FIG. 2f. A quadrilateral shape may also be in the form of a meander as shown in FIG. 2g. Further shapes are possible, for example, with an angle and undercut.

All of the cases shown in FIG. 2b to FIG. 2g result in a considerably enlarged active surface area in comparison to the active surface area of the prior art as shown in FIG. 2a.

FIG. 3 shows a stack formed by two ceramic structures as shown in FIG. 1, which each form a single fuel cell, with the stacking being carried out in the same phase. A flexible knitted fabric 50, composed in particular of nickel, is located between the two ceramic structures 10, 10′ and makes the electrical contact between the nickel plating 41 on the interconnector strip 40 and the anode 30, which are not shown in detail in FIG. 3.

The interconnector 40 is formed in a known manner from electron-conducting lanthanum chromate, which has been found to be suitable for long-term applications and, in particular, has also been found to be resistant to oxidation. In order to compensate for mechanical stresses, the interconnector 40 makes an electrically conductive contact within the adjacent cell via the contact body 50, which is composed of metal mesh, woven fabric or else is formed by a felt composed of nickel.

A large number of individual fuel cells 10, 10′, form a stack, with side boards being provided for holding purposes. A stack such as this forms the core of a complete fuel cell installation. In this case, the fuel gas flows around the stack in a container, without any gas guidance structures.

It may be worthwhile in each case offsetting two individual fuel cells with respect to one another by half the period structure with respect to one another in order to form a stack, in order to distribute the contact points between the fuel cells which are stacked one on top of the other. This is illustrated in FIG. 4, for the fuel cells 20, 201, . . . In this case, nothing is changed with regard to the method of operation of the complete stack.

Particularly in the case of the arrangement shown in FIG. 4, mechanical stresses are avoided in comparison to monolithic or planar fuel cells. The metallic contact elements may also be mats, chords, metal mesh, stamped/embossed moldings or combinations/mixed forms.

The following table shows a performance comparison of previous cell types (tube, HPD4, HPD5, HPD10, HPD11) with cell types delta 9-63° and delta 9-78° according to the invention. In this case, the tubular “tube” cell which has been used until now has an active length of 150 cm, while all the HPD and delta cells have an active length of 50 cm.

TABLE

| | Tube | HPD4 | HPD5 | HPD10 | HPD11 | Delta 9 63° | Delta 9 78° |
|---|---|---|---|---|---|---|---|
| | 150 cm | 50 cm | 50 cm | 50 cm | 50 cm | 50 cm | 50 cm |
| Number of | 40 | 57 | 28 | 26 | 25 | 16 | 14 |
| cells per 5 kW | | | | | | | |
| Cell power (W) | 126 | 88 | 177 | 191 | 198 | 321 | 362 |
| Power to weight | 113 | 191 | 158 | 217 | 275 | 308 | 332 |
| ratio (W/kg) | | | | | | | |
| Power to volume | 136 | 297 | 262 | 394 | 447 | 542 | 563 |
| ratio (kW/m³) | | | | | | | |

The rows in the table show the number of cells per 5 kW, the cell power and, as major comparison criteria, the power to weight ratio and the power to volume ratio.

The prior art discloses the formation of the cells as individual tubes or as an HPD cell with four, five, ten or eleven hollow channels. The embodiments according to the invention are listed in the last two columns, and are compared with the prior art.

The previous development has already shown that the replacement of the tubes by HPD cells leads to smaller components, and that this increases the power to weight ratio and/or the power to volume ratio. Beyond this, the new technology delta 9 further increases the power yield.

Overall, the table shows a considerable power increase for the fuel cells according to an embodiment of the invention. Since the effort for production of cells such as these as a result of further-developed extrusion and coating technologies is essentially the same as in the case of the previous cells, this results in a particularly advantageous price to power ratio for fuel cells.

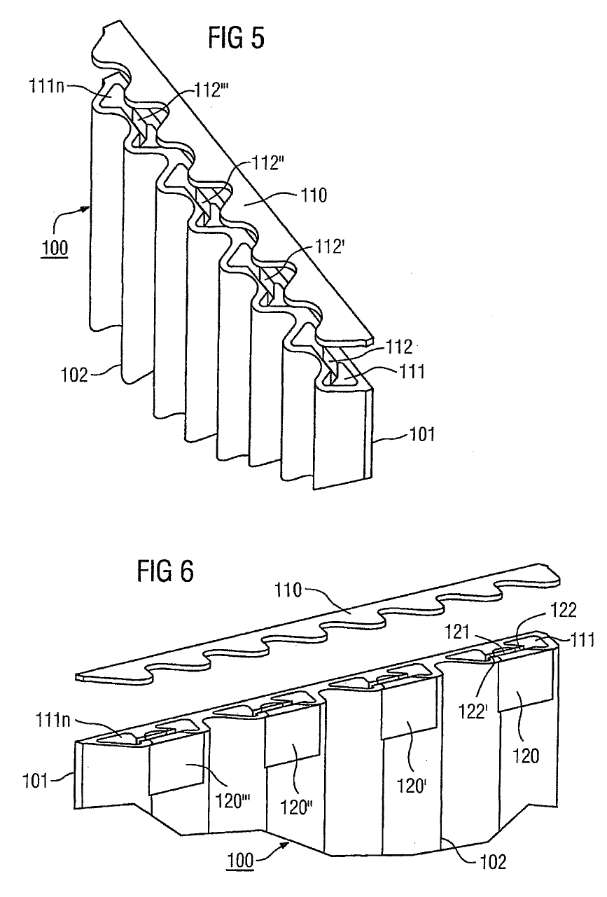

FIGS. 5 to 8 show a delta fuel cell 100. This includes a ceramic structure with a planar base 101 and a structure 102 with a specific shape located on it. By way of example, the structure 102 may be a wave structure or a triangular structure, in which case, in particular, the apex angle α of this structure is predetermined. For example, angles α of 60, 45 or 30° may be predetermined.

The base part 101 and the structure 102 form a common unit, and are extruded jointly from a ceramic material which is suitable for SOFC fuel cells.

One major feature of the structure shown in FIG. 1 and FIG. 5 is that the electrochemically active surface is enlarged in comparison to the known HPD fuel cell with a planar surface. This is achieved, for example, with a wave or triangular structure, in which case the flanks may be stepped in order to additionally increase the surface area.

Delta fuel cells as described above can be stacked to form a fuel cell installation. The insertion of a complementary structure into the respective end areas of the fuel cell allows a fuel cell bundle to be formed which can be stacked, can be sealed externally and has improved gas connection devices, in particular defined gas inlets/outlets. This thus results in individual modules for the fuel cell installation.

In the case of the fuel cell described here, the air is carried in the interior of the channels, and the fuel gas is carried in the open channels on the outside of the cells. In this case, the air is in general introduced in every alternate channel from one end of the fuel cell in each case and, after passing through the entire length of the fuel cell, is deflected and is passed back on a parallel path. Thus, the air must be deflected through 180° at the end of the fuel cell.

The air is advantageously passed out at the side, at the open end. This means that, in this case, the air is deflected such that the channels with the fed-back air are opened, and meet a connecting channel of the adjacent cell.

One major aspect initially is the air deflection at the closed end of the fuel cell. Various alternatives are possible for this purpose, which will be described in detail with reference to FIGS. 5 to 7.

FIG. 5 shows one such delta fuel cell with an even number of flow channels 111, 111′, . . . , for example with eight channels. In this case, two adjacent channels are in each case associated with one another, that is to say the air is carried in the first channel from the open end to the closed end, where it is deflected to the adjacent channel, and is fed back in this channel.

If the delta fuel cell is extruded in a suitable manner with thickened connecting webs in every alternate sink and is sufficiently robust, two adjacent channels 111, 111′ can be connected in a simple manner by a transverse channel 112. Thus, of the eight fuel cell channels in FIG. 2, two adjacent channels each have the transverse channel 112 at the closed end. The entire arrangement is closed at the end by a plate 110.

As an alternative to FIG. 5, a cell with uniform recesses and any desired number of channels can be chosen. As shown in FIG. 6, eight channels 111, 111′, . . . are once again provided in the fuel cell 100 with a cover 110. In this case, however, a molding 120, 120′ is introduced into each recess or into every alternate recess in the wave structure. The moldings 120, 120′, . . . , each have a transverse channel 121, 121′, . . . Associated transverse channels 121, 121′ in the individual fuel cell channels 111, 111′, . . . are in this case used to provide the connection to the second air guidance channel 101 from the first air guidance channel 101 via the first channel 121′, the transverse channel 113 and a second channel 121′.

The two examples shown in FIG. 5 and FIG. 6 have an even number of air guidance channels. This results in a system eminent connection, in that the air is guided in the opposite direction in the two edge channels of the delta fuel cell.

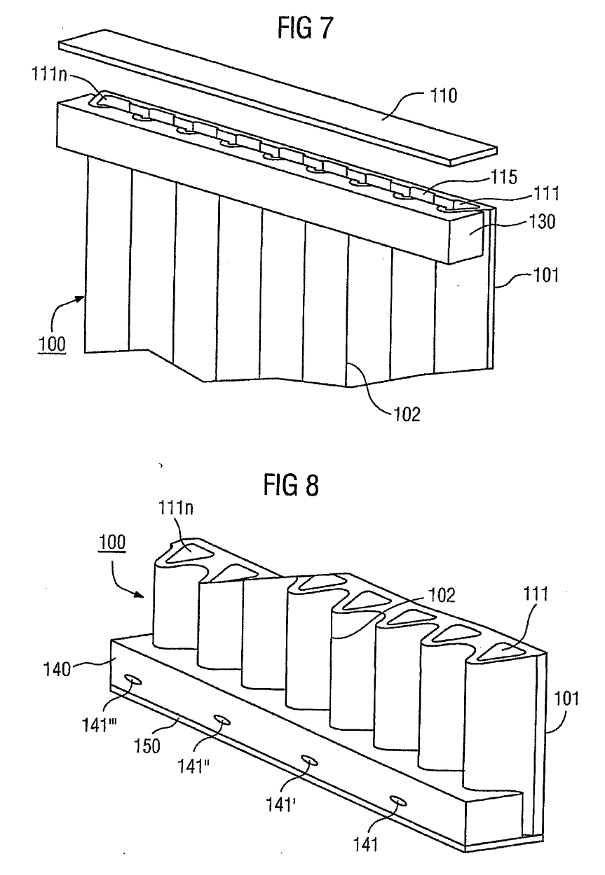

In a further alternative embodiment shown in FIG. 7, a continuous transverse channel 115 is introduced over the end of the entire delta fuel cell 100. Thus, all eight air guidance channels 111 to 111′, . . . are connected to one another for fluid-flow purposes. When air is applied to the individual channels from the input side, it is thus possible for the air to flow out via one or more channels and to flow back in any desired number of other channels. In this case, once again, a cover 110 is provided, as well as a complementary molding 130.

If a part is inserted into each recess in the fuel cell shown in FIG. 6, a continuous transverse channel is also possible in this embodiment. From the production engineering point of view, the parts are composed of the same basic material and are inserted as separate green products, and are sintered together with the fuel cell structure.

As can be seen in FIG. 8, a complementary part 40 is likewise placed on the wave structure in the input area of the fuel cell 100. In FIG. 8, it is advantageous for the air to be supplied from underneath, and for the air to be carried away at the side through openings 141, 141′, . . . , as discrete outlets. The fuel cell 100 is closed at the bottom by a cover 150 which, as a base plate, also covers the closed complementary part 140.

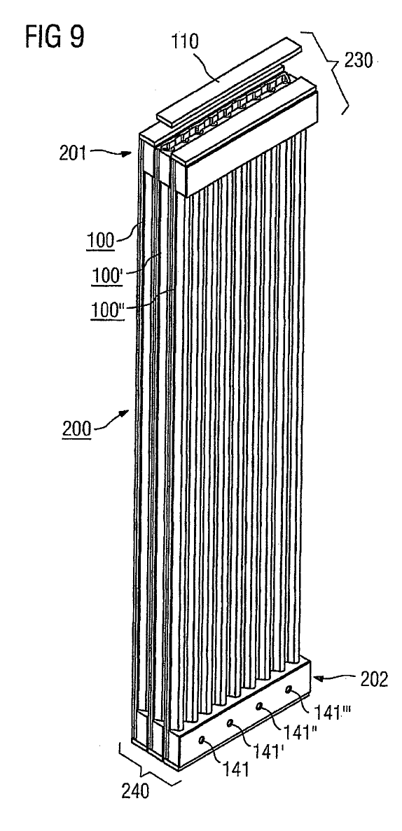

FIG. 9 shows a fuel cell bundle including three delta fuel cells 100, 100′, 100″ with an air inlet/outlet as shown in FIG. 8 and with air deflection as shown in FIG. 7. In this case, the fuel cells are stacked in the same phase to form a stack through which a fuel gas can flow in a container without gas guidance structures. A stack such as this forms the core of a fuel cell installation.

The individual delta fuel cells 100, 100′, 100″ in the example embodiment illustrated in FIG. 9 each have nine channels, so that the flow conditions are the same at both edges, with suitable flow deflection as shown in FIG. 7.

In the arrangement shown in FIG. 9, the air clearly flows upwards from the bottom upwards (“up”), is deflected in the end part, and then flows from the top downwards (“down”), with the air flowing out at the side at the lower end.

In principle, the arrangement of the fuel cell bundle can also be oriented in the opposite sense. A horizontally aligned arrangement is also possible.

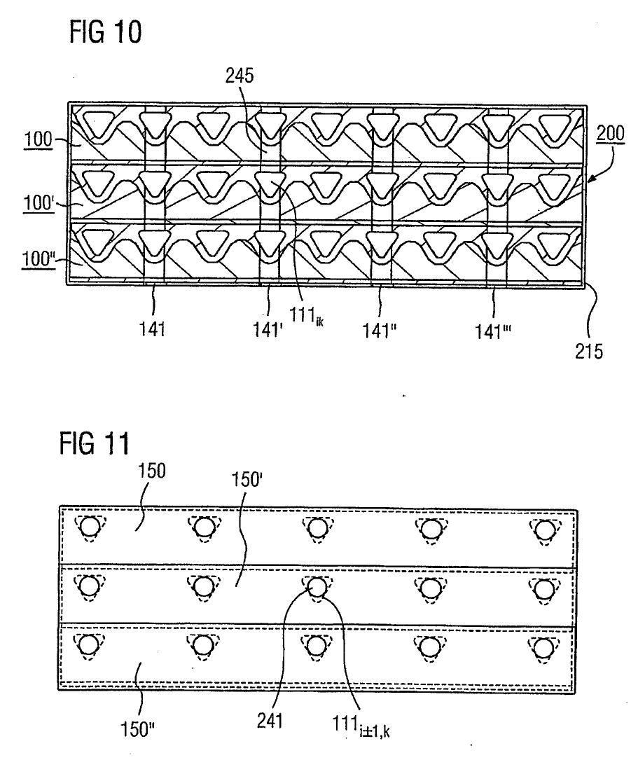

FIG. 10 shows a cross section through the bundle 125 on the plane of the side air outlets. As can be seen, in the individual delta fuel cells 100, 100′, 100″, the air guidance channels 111ᵢₖ (i=1−m, k=1−n) of every alternate column of the fuel cells 100, 100′, 100″ which are stacked in the same phase are each connected to one another by a transverse channel 245, which leads to the external outlets 141, 141′, . . . In this illustration, the inlets are connected in a singular form to the individual air inlet channels.

As can be seen in FIG. 10, a plan view of the lower cover shows individual inlets 241, which correspond with the open air guidance channels 111_{1+1,k}.

The end parts or stacked parts in FIG. 9 are connected to one another in a gas-tight manner by means of a glass solder, and form compact connecting blocks. These areas, which are inactive for the fuel-cell function, are covered with the electrolyte of the active fuel cells, as is indicated by the layer 215 in FIG. 10.

Corresponding to FIG. 9, a stackable arrangement of a fuel cell bundle for a fuel cell installation is created overall with the connecting blocks 230 and 240. There is sufficient space between the connecting blocks in order to electrically connect the individual delta fuel cells in a known manner by way of a felt or mesh composed of nickel (Ni) or a Ni—Cr alloy.

If the fuel cell installation is configured as shown in FIGS. 9 to 11, it is particularly advantageous for compact supporting parts to be formed at each of the ends of the fuel cells. These parts comprise the inactive areas of the individual delta fuel cells and the complementary parts for the wave structure, in which case, as already mentioned, the individual fuel cells are connected to one another by way of the glass solder in this area, and the compact assembly is in each case surrounded, as a connecting block, by the electrolyte film.

The arrangements described above apply to all known variants of supporting structures, to be precise for cathode-supported, anode-supported or neutral structures. In addition to the described wave or triangular geometry (delta) of the fuel cells, the described features also apply to other geometries, as have been described. The important factor is the enlargement of the electrochemically active surface area and the specific deflection of the air flow in the air guidance channels by suitable devices/methods. These devices/methods result in a direction reversal at the cell end, in particular through 180°, or at the outlet, in particular through 90°.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A high-temperature solid-electrolyte fuel cell including a porous conductive supporting structure for the gas line, the structure of the fuel cell including:
a wave structure,
a folded shape of the wave structure resulting in the porous conductive structure with an integrated gas line hollow structure and gas line channels with respect to the supporting structure surface being partially geometrically enlarged in comparison to a planar surface, thus resulting in an enlarged electrochemically active surface area, and thus increased electrical power of the cell,
at least one of the corners and edges of the gas line channels being at least one of rounded and flattened.

2. The fuel cell as claimed in claim 1, wherein the channel cross sections essentially have a triangular shape.

3. The fuel cell as claimed in claim 2, wherein an apex angle is less than 150°.

4. The fuel cell as claimed in claim 3, wherein the apex angle is between 90 and 30°.

5. The fuel cell as claimed in claim 1, wherein the flanks of the wave structure are stepped.

6. The fuel cell as claimed in claim 1, wherein the channel cross sections have at least one of a rectangular shape and a meandering shape.

7. The fuel cell as claimed in claim 1, wherein the channel cross sections have a uniformly curved shape, in particular an oval shape.

8. The fuel cell as claimed in claim 1, wherein the supporting structure forms the cathode to which a solid electrolyte and an anode are applied.

9. The fuel cell as claimed in claim 1, wherein the supporting structure forms the anode, to which a solid electrolyte and a cathode are applied.

10. The fuel cell as claimed in claim 1, wherein the supporting structure to which a cathode, a solid electrolyte and an anode are applied is electrochemically neutral.

11. The fuel cell as claimed in claim 1, wherein at least one interconnector strip is applied as an electrical contact to the rear face of the supporting structure.

12. The fuel cell as claimed in claim 11, wherein the electrical contact with the adjacent cell is made via at least one of nickel or Ni—Cr alloy meshes, knitted fabrics, felts and other flexible structures.

13. A fuel cell installation having at least two solid electrolyte fuel cells as claimed in claim 1, wherein an active cell face of the individual fuel cell has an enlarged surface in comparison to a planar surface, and wherein a plurality of solid-electrolyte fuel cells form a stack with a non-monolithic structure.

14. The fuel cell installation as claimed in claim 13, wherein the fuel cells are stacked periodically in the same phase in order to form a stack.

15. The fuel cell installation as claimed in claim 13, wherein the fuel cells are each shifted in pairs through half the period length in order to form a stack.

16. The fuel cell installation as claimed in claim 13, wherein two fuel cells are connected via a flexible contact connector.

17. The fuel cell installation as claimed in claim 14, wherein the contact connector is in the form of at least one of a mesh, a knitted fabric and felt composed of nickel or a Ni—Cr alloy.

18. The fuel cell installation as claimed in claim 15, wherein the stack is held at the sides by holding elements.

19. The fuel cell installation as claimed in claim 20, wherein a fuel gas flows around the stack in a container, without gas guidance structures.

20. A high-temperature solid-electrolyte fuel cell as claimed in claim 1, further comprising means for integrated air deflection from one predetermined flow direction to a further flow direction.

21. The fuel cell as claimed in claim 20, wherein the means for integrated air deflection from a first flow direction to a second flow direction include means for flow reversal.

22. The fuel cell as claimed in claim 21, wherein the means for integrated air deflection from the first-flow direction to the second flow direction include further means for flowing out at the side.

23. The fuel cell as claimed in claim 21, wherein the first flow direction is an upward flow and the second flow direction is a downward flow.

24. The fuel cell as claimed in claim 20, wherein the flow reversal at the channel end and the reverse flow in at least one parallel channel are followed by an outward flow at the side at an angle of 90°.

25. The fuel cell as claimed in claim 20, wherein the surface of the supporting structure is a wave structure on the active cell face.

26. The fuel cell as claimed in claim 20, wherein two adjacent flow channels are respectively connected for fluid-flow purposes via channels.

27. The fuel cell as claimed in claim 26, wherein all of the flow channels are connected for fluid-flow purposes via a transverse groove.

28. The fuel cell as claimed in claim 26, wherein moldings, composed of the same material as the supporting structure, are included as the means for air deflection and include inner lumina which connect the adjacent flow channels for fluid-flow purposes.

29. The fuel cell as claimed in claim 28, wherein the walls of adjacent flow channels include channels which are connected to the inner lumina of the moldings.

30. The fuel cell as claimed in claim 29, wherein the moldings and the fuel cells are connected by sintering to form one component.

31. A fuel cell installation comprising at least two solid-electrolyte fuel cells as claimed in claim 20, wherein the active cell face of the individual fuel cell has an enlarged surface in comparison to a planar surface, with a plurality of cells forming a cell bundle as a stack, individual cells being soldered to one another at the ends, with blocks being inserted as spacers at the ends of the cells of which the block at the closed end of the cell bundle contains means for internal air deflection.

32. The fuel cell installation as claimed in claim 31, wherein the fuel cells are stacked periodically in the same phase as a cell bundle in order to form a stack.

33. The fuel cell installation as claimed in claim 20, wherein a fuel gas flows through the stack in a container, without gas guidance structures.

34. The fuel cell installation as claimed in claim 33, wherein air guidance channels which carry outlet air are connected to one another via transverse channels for fluid-flow connection of individual fuel cells.

35. The fuel cell as claimed in claim 33, wherein the second flow direction runs in that channel of the fuel cell which is adjacent to the first flow direction.

36. The fuel cell installation as claimed in claim 33, wherein the second flow direction runs in the fuel cell which is adjacent to the first flow direction.

37. (canceled)

38. (canceled)

39. The fuel cell as claimed in claim 2, wherein the flanks of the triangular structure are stepped.

40. The fuel cell as claimed in claim 1, wherein the channel cross sections have an oval shape.

41. The fuel cell as claimed in claim 21, wherein the flow reversal at the channel end and the reverse flow in at least one parallel channel are followed by an outward flow at the side at an angle of 90°.

42. The fuel cell installation as claimed in claim 13, wherein the fuel cells are stacked periodically in the same phase as a cell bundle in order to form a stack.

43. The fuel cell installation as claimed in claim 13, wherein a fuel gas flows through the stack in a container, without gas guidance structures.

44. The fuel cell installation as claimed in claim 13, wherein the second flow direction runs in the fuel cell which is adjacent to the first flow direction.
